(19) United States
(12) Patent Application Publication
(10) Pub. No.: US 2025/0223015 A1
(43) Pub. Date: Jul. 10, 2025

(54) SWINGING WING PLATE STRUCTURE FOR PROVIDING BUOYANCY FOR SHIP BODY AND SHIP BODY WITH WING PLATE STRUCTURE

(71) Applicant: ANHUI ANHUA MACHINERY TECHNOLOGY CO., LTD., Bengbu (CN)

(72) Inventors: Xuming TANG, Bengbu (CN); Anding LIU, Bengbu (CN)

(73) Assignee: ANHUI ANHUA MACHINERY TECHNOLOGY CO., LTD., Bengbu (CN)

(21) Appl. No.: 18/856,896

(22) PCT Filed: Jan. 17, 2022
(86) PCT No.: PCT/CN2022/072217

§ 371 Date: Oct. 15, 2024

(30) Foreign Application Priority Data
Jan. 10, 2022 (CN) 202210022654.9

(51) Int. Cl. B63B 39/06

(52) U.S. Cl. CPC B63B 39/06

(57) ABSTRACT

Disclosed in the present disclosure are a swinging wing plate structure for providing buoyancy for a ship body and the ship body with the wing plate structure, relating to the technical field of boats and ships. The ship body includes a ship main body, where the ship main body is provided with vertical structures on two sides and inclined plates in front and rear, two ends of the vertical structures on the two sides extend out of the inclined plates in the front and rear of the ship main body, lower ends of the vertical structures extend out of a bottom of the ship main body, accommodating grooves are provided on the two sides of the ship main body, a portal arranged vertically is provided in the accommodating grooves, two sides of the portal are provided with vertical slide rails, slide plates are slidably connected to the vertical slide rails, first hydraulic cylinders are arranged on the portal, piston rods of the first hydraulic cylinders are connected to the slide plates, the slide plates are provided with wing plates, and ends of the wing plates extend out of the two sides of the ship main body. The vertical structures on the two sides of the ship main body reduces an influence of waves, when a ship reaches a certain speed, the wing plates are unfolded, then the wing plates make contact with a water surface, and the wing plates are lifted by water flow, so as to increase the buoyancy of the ship main body and increase a ship speed.

### TECHNICAL FIELD

The present disclosure relates to the technical field of boats and ships, and particularly relates to a swinging wing plate structure for providing buoyancy for a ship body and the ship body with the wing plate structure.

### BACKGROUND TECHNOLOGY

Ship draught generally refers to a depth of Boats and ships immersion in water. It refers to a vertical distance from the bottom of a ship to where a ship body is connected to a water surface, which indirectly reflects buoyancy experienced by the ship (or the weight of the ship and cargoes, etc. as this is equal to the buoyancy experienced by the ship) during traveling. So the greater the draught of the ship body is, the greater the capacity of the ship body to carry cargoes is.

The greater the draught of the ship body is, the greater the resistance received is, the greater the energy consumption is, which affects a speed, and thus, reducing the draught is conducive to the reduction in energy consumption and increase in speed based on a stable ship body.

### CONTENT OF THE INVENTION

In order to reduce a draught, raise buoyancy of a ship, and increase a ship speed, the present disclosure provides a swing wing plate structure for providing buoyancy for a ship body and the ship body with the wing plate structure.

The following technical solutions are used for solving the technical problems of the present disclosure.

A swinging wing plate structure for providing buoyancy for a ship body includes a portal arranged on the ship body, where two sides of the portal are provided with vertical slide rails, slide plates are slidably connected to front surfaces of the vertical slide rails, first hydraulic cylinders are arranged on the portal, piston rods of the first hydraulic cylinders are connected to the slide plates, the slide plates are provided with wing plates, and ends of the wing plates extend out of two sides of the ship body.

The present disclosure has a further technology:

Preferably, the slide plates includes first slide plates and second slide plates, the first slide plates are fixedly connected to the second slide plates correspondingly, the piston rods of the first hydraulic cylinders are connected to the first slide plates.

Preferably, the wing plates are movably connected to the second slide plates, a connection structure is a connection frame hinged to the second slide plates and the wing plates connected to the connection frame, transverse supports are connected to the first slide plates, second hydraulic cylinders are hinged to the transverse supports, and piston rods of the second hydraulic cylinders are hinged to the wing plates.

Preferably, the connection frame is provided with slide grooves, limiting plates and first pulley assemblies, where
positioning rings are arranged on the slide grooves, movable clamping plates slidable in the slide grooves are accommodated in the slide grooves, the movable clamping plates penetrate the positioning rings, insertion holes are provided in one sides of the movable clamping plates, insertion rods are connected to the limiting plates, the insertion rods are inserted into the insertion holes, compression springs sleeve the insertion rods, one ends of the compression springs abut against the limiting plates, the other ends abut against the movable clamping plates, pull rings are arranged on the movable clamping plates, hoists are arranged on the first slide plates, second pulley assemblies are arranged on the second slide plates, and steel wire ropes of the hoists pass around the second pulley assemblies and the first pulley assemblies in sequence, and then attach to the pull rings.

Preferably, an upper surface of each wing plate is a downwardly curved arc surface, a lower surface of each wing plate is a curved step surface, step drops are connected by an arc surface, and each wing plate is an arc plate with a section of a pressing down structure.

Preferably, free ends of the wing plates are provided with vertical plates, lower surfaces of the wing plates are provided with ribs, and the ribs are arranged parallel to the vertical plates.

Preferably, each wing plate uses a combined structure of an outer frame and an inner swing plate, the outer frames are hinged to the inner swing plates, third hydraulic cylinders are arranged on the connection frame, and piston rods of the third hydraulic cylinders are hinged to the inner swing plates.

The present disclosure further provides a ship body with the above wing plate structure. The ship body includes a ship main body, where the ship main body is provided with vertical structures on two sides and inclined plates in front and rear, two ends of the vertical structures on the two sides extend out of the inclined plates in the front and rear of the ship main body, lower ends of the vertical structures extend out of a bottom of the ship main body, accommodating grooves are provided on the two sides of the ship main body, and wing plate structures are arranged in the accommodating grooves.

The present disclosure has the following beneficial effects:

When a ship reaches a certain speed, the wing plates are unfolded, then the wing plates make contact with a water surface, and the wing plates are lifted by water flow, so as to increase the buoyancy of the ship main body and increase a ship speed.

### DESCRIPTION OF THE DRAWINGS

In order to more clearly illustrate technical solutions in the embodiments of the present disclosure, a brief introduction to the accompanying drawings required for the description of the embodiments will be provided below. Obviously, the accompanying drawings in the following description are only some of the embodiments of the present invention, and those ordinary skill in the art would also be able to derive other drawings from these drawings without making creative efforts.

FIG. 1 is a schematic diagram of a connection structure of a wing plate according to the present disclosure;

FIG. 2 is a schematic structural diagram of a connection frame according to the present disclosure;

FIG. 3 is a schematic structural diagram of a wing plate according to the present disclosure;

FIG. 4 is a schematic side view of a structure according to the present disclosure;

FIG. 5 is a schematic sectional view of a ship body structure according to the present disclosure; and

### BRIEF DESCRIPTION OF THE REFERENCE NUMERALS

1. ship main body; 2. accommodating groove; 3. portal; 4. first slide plate; 5. first hydraulic cylinder; 6. wing plate; 7. second hydraulic cylinder; 8. connection frame; 9. vertical plate; 10. rib; 11. second slide plate; 12. slide groove; 13. limiting plate; 14. first pulley assembly; 15. positioning ring; 16. movable clamping plate; 17. insertion hole; 18. insertion rod; 19. compression spring; 20. hoist; 21. second pulley assembly; 22. outer frame; 23. inner swing plate; 24. third hydraulic cylinder; and 25. pull ring.

### Specific Implementations

For making the objectives, technical solutions and advantages of embodiments of the present disclosure more obvious, the technical solutions of the present disclosure will be clearly and completely described below in conjunction with the embodiments of the present disclosure, and obviously, the described embodiments are some, rather than all of the embodiments of the present disclosure. Based on the embodiments of the present invention, other various embodiments obtained by those of ordinary skill in the art without making creative efforts fall within the scope of protection of the present invention.

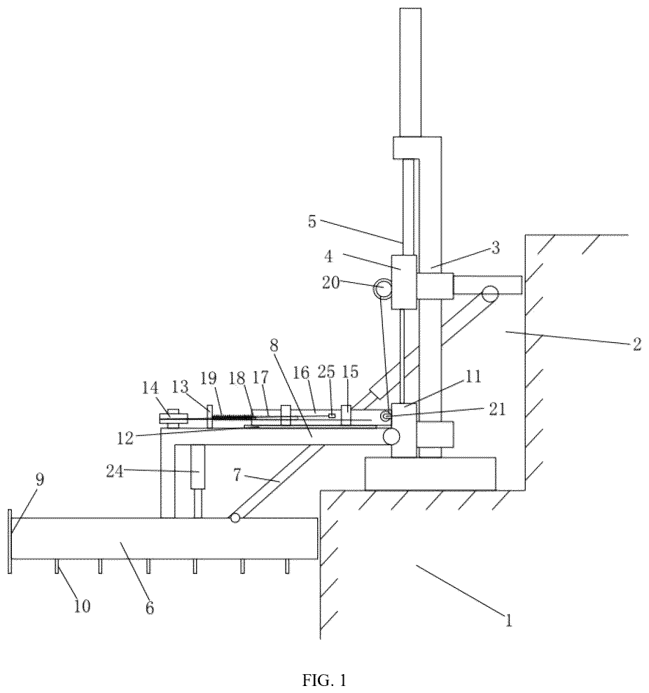

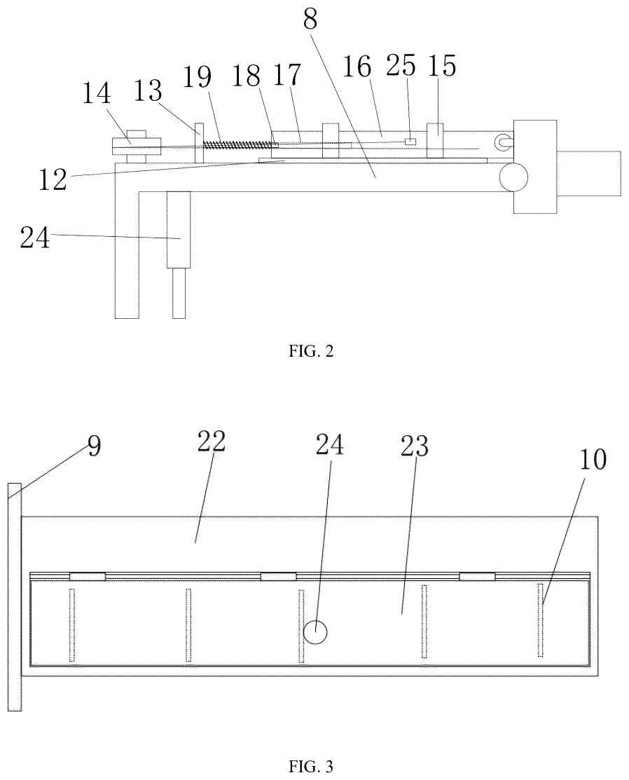

As shown in FIGS. 1-2, a swinging wing plate structure for providing buoyancy for a ship body includes a portal 3 arranged on the ship body, where two sides of the portal 3 are provided with vertical slide rails, slide plates are slidably connected to the vertical slide rails, first hydraulic cylinders 5 are arranged on the portal 3, piston rods of the first hydraulic cylinders 5 are connected to the slide plates, the slide plates 4 are provided with wing plates 6, and ends of the wing plates 6 extend out of two sides of the ship main body 1.

It is to be noted that a top end of the portal 3 in the embodiment is higher than the ship body and controls the wing plates 6 to move up and down by means of the first hydraulic cylinders 5. In the embodiment, when the wing plates 6 are located at a lowermost end with respect to a deep draught, the wing plates may make contact with a water surface. According to the draught, the wing plates 6 are adjusted to keep lower surfaces of the wing plates 6 making contact with the water surface.

The slide plates includes first slide plates 4 and second slide plates 11, the first slide plates 4 are fixedly connected to the second slide plates 11 correspondingly, the piston rods of the first hydraulic cylinders are connected to the first slide plates 4.

The wing plates are movably connected to the second slide plates 11, a connection structure is a connection frame hinged to the second slide plates 11 and the wing plates connected to the connection frame, transverse supports are connected to the first slide plates 4, second hydraulic cylinders are hinged to the transverse supports, and piston rods of the second hydraulic cylinders are hinged to the wing plates.

The piston rods of the second hydraulic cylinders in the present disclosure penetrate between the first slide plates 4 and the second slide plates 11, and moreover, movable spaces of the second hydraulic cylinders are reserved when the wing plates are pulled from a horizontal state to a vertical state.

It is to be noted that when a ship reaches a certain speed, the wing plates 6 are unfolded, then the wing plates 6 make contact with a water surface, and the wing plates 6 are lifted by water flow, so as to increase the buoyancy of the ship main body 1 and increase a ship speed.

It is to be noted that in a longest state of the piston rods of the first hydraulic cylinders 5, the second slide plates 11 are pushed to groove bottoms of the accommodating grooves 2. In a shortest state of the first hydraulic cylinders, the first slide plates 4 are pulled to groove tops of the accommodating grooves 2. The piston rods of the second hydraulic cylinders 7 may pull the wing plates from the horizontal state to the vertical state.

In the present disclosure, when the wing plates are in the horizontal state, it may occur that movable ends of the wing plates is lifted up due to an impact of water flow, so as to need the second hydraulic cylinders for strongly pressing; and in order to avoid this situation, the connection frame is provided with slide grooves 12, limiting plates 13 and first pulley assemblies 14.

As shown in FIG. 2, positioning rings 15 are arranged on the slide grooves 12, movable clamping plates 16 slidable in the slide grooves 12 are accommodated in the slide grooves 12, the movable clamping plates 16 penetrate the positioning rings 15, insertion holes 17 are provided in one sides of the movable clamping plates 16, insertion rods 18 are connected to the limiting plates 13, the insertion rods 18 are inserted into the insertion holes 17, compression springs 19 sleeve the insertion rods 18, one ends of the compression springs 19 abut against the limiting plates 13, the other ends abut against the movable clamping plates 16, pull rings 25 are arranged on the movable clamping plates 16, hoists 20 are arranged on the first slide plates 4, second pulley assemblies 21 are arranged on the second slide plates 11, and steel wire ropes of the hoists 20 pass around the second pulley assemblies 21 and the first pulley assemblies 14 in sequence, and then attach to the pull rings.

In the above structure, when the compression springs 19 are in a normal state, the other ends of the movable clamping plates 16 abut against the second slide plates 11, two corresponding sides make contact to form one push block structures, and movement of the movable clamping plates 16 in the slide grooves 12 keeps penetrating the positioning rings 15 to avoid disengaging from the slide grooves 12. When the wing plates needs to be folded, the hoists 20 are turned on to pull the steel wire ropes and then to pull the pull rings 25, the movable clamping plates 16 moves, the compression springs 19 are compressed, end surfaces of the movable clamping plates 16 are separated from the second slide plates 11, and the wing plate may be folded.

An upper surface of each wing plate 6 is a downwardly curved arc surface, a lower surface of each wing plate is a curved step surface, step drops are connected by an arc surface, and each wing plate 6 is an arc plate with a section of a pressing down structure.

Free ends of the wing plates 6 are provided with vertical plates 9, lower surfaces of the wing plates 6 are provided with ribs 10, and the ribs 10 are arranged parallel to the vertical plates 9.

As shown in FIG. 3, each wing plate uses a combined structure of an outer frame 22 and an inner swing plate 23, the outer frames 22 are hinged to the inner swing plates 23, third hydraulic cylinders 24 are arranged on the connection frame, and piston rods of the third hydraulic cylinders 24 are hinged to the inner swing plates 23.

An angle of the inner swing plates 23 may be adjusted according to a water flow speed, and the buoyancy may be increased in accordance with the water flow speed.

It is worth noting that the first hydraulic cylinders 5, the second hydraulic cylinders 7 and the third hydraulic cylinders 24 may be replaced by air cylinders, and are controlled by means of a programmable logic controller (PLC) remote control module, and an apparatus matching the PLC remote control module is a common apparatus and belongs to an existing mature technology, such that a electrical connection relation and a specific circuit structure are not repeated here.

Moreover, it is to be noted that the present disclosure preferably uses the first hydraulic cylinders 5, the second hydraulic cylinders 7, and the third hydraulic cylinders 24, and may also use are cylinders, screws, etc.

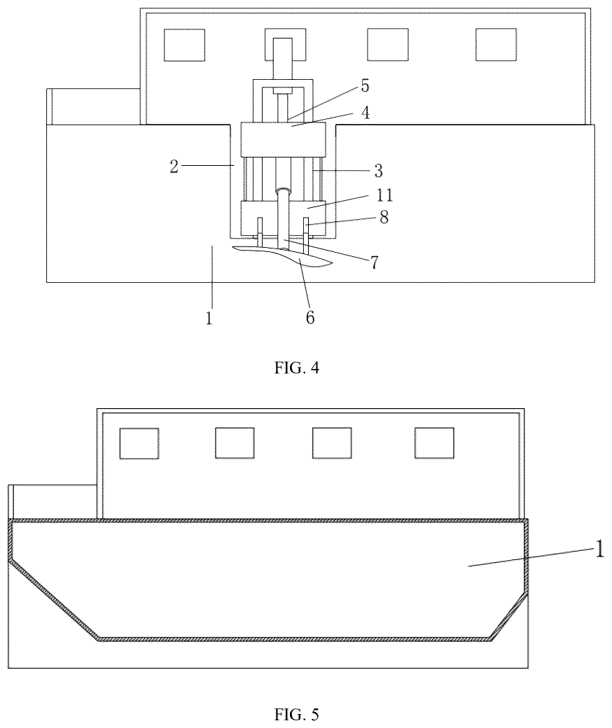

As shown in FIG. 4-5, the embodiments further provide a ship body structure with wing plates 6 on two sides. The ship body structure includes a ship main body 1, where the ship main body 1 is provided with vertical structures on two sides and inclined plates in front and rear, two ends of the vertical structures on the two sides extend out of the inclined plates in the front and rear of the ship main body 1, and lower ends of the vertical structures extend out of a bottom of the ship main body 1.

The water flow is guided between the vertical structures at two sides, and it is difficult for the water flow to expand to the outside of the vertical structures passing through the front and rear inclined plates, thus greatly reducing waves generated by breaking water.

Accommodating grooves 2 are provided on two sides of the ship main body 1, and the above wing plate structure is arranged in the accommodating grooves 2.

The vertical structures on the two sides reduces the waves, and more importantly, reduces an influence of the waves on the wing plates 6. In the prior art, the ship body is additionally provided with the wing plate 6 structure, however, waves make the water surface uneven, and the wing plates may not be used. The wing plates 6 needs a smooth water surface, the lower surfaces of the wing plates 6 are located below the water surface, and the upper surfaces are located above the water surface, such that the buoyancy of the ship body is increased by the water flow passing through the wing plates 6 and lifting the wing plate 6.

It is to be explained that the relation terms, for example, first, second, etc., are used herein merely for distinguishing one entity or operation from another entity or operation but do not necessarily require or imply that there exists any actual relation or sequence between these entities or operations. Furthermore, terms “comprising”, “including” or any other variants are intended to cover the non-exclusive including, thereby making that the process, method, object or apparatus comprising a series of elements comprise not only those elements but also other elements that are not listed explicitly or the inherent elements to the process, method, merchandise or apparatus. In the case of no more limitations, the element limited by the sentence “comprising a . . . ” does not exclude that there exists another same element in the process, method, merchandise or apparatus comprising the element.

In the present disclosure, unless expressly stated or limited, features are interleaved and do not necessarily exist independently. The foregoing showing and description include basic principles, principal features, and advantages of the present disclosure. It will be appreciated by persons skilled in the art that the present disclosure is not limited to the embodiments described above, the embodiments together with the description are merely preferred embodiments of the present disclosure and are not intended to limit the present disclosure so as to be solely selected. The present disclosure is amenable to further modification and optimization within the spirit and scope of the present disclosure, the modifications and optimization of the present disclosure fall within the claimed scope of the present disclosure, and it is intended that the present disclosure is defined by the appended claims and their equivalents.

1. A swinging wing plate structure for providing buoyancy for a ship body, comprising a portal arranged on the ship body, wherein two sides of the portal are provided with vertical slide rails, slide plates are slidably connected to front surfaces of the vertical slide rails, first hydraulic cylinders are arranged on the portal, piston rods of the first hydraulic cylinders are connected to the slide plates, the slide plates are provided with wing plates, and ends of the wing plates extend out of two sides of the ship body.

2. The swinging wing plate structure for providing buoyancy for a ship body according to claim 1, wherein the slide plates comprise first slide plates and second slide plates, the first slide plates are fixedly connected to the second slide plates correspondingly, the piston rods of the first hydraulic cylinders are connected to the first slide plates.

3. The swinging wing plate structure for providing buoyancy for a ship body according to claim 2, wherein the wing plates are movably connected to the second slide plates, a connection structure is a connection frame hinged to the second slide plates and the wing plates connected to the connection frame, transverse supports are connected to the first slide plates, second hydraulic cylinders are hinged to the transverse supports, and piston rods of the second hydraulic cylinders are hinged to the wing plates.

4. The swinging wing plate structure for providing buoyancy for a ship body according to claim 3, wherein the connection frame is provided with slide grooves, limiting plates and first pulley assemblies, wherein
positioning rings are arranged on the slide grooves, movable clamping plates slidable in the slide grooves are accommodated in the slide grooves, the movable clamping plates penetrate the positioning rings, insertion holes are provided in one sides of the movable clamping plates, insertion rods are connected to the limiting plates, the insertion rods are inserted into the insertion holes, compression springs sleeve the insertion rods, one ends of the compression springs abut against the limiting plates, the other ends abut against the movable clamping plates, pull rings are arranged on the movable clamping plates, hoists are arranged on the first slide plates, second pulley assemblies are arranged on the second slide plates, and steel wire ropes of the hoists pass around the second pulley assemblies and the first pulley assemblies in sequence, and then attach to the pull rings.

5. The swinging wing plate structure for providing buoyancy for a ship body according to claim 3, wherein each wing plate uses a combined structure of an outer frame and an inner swing plate, the outer frames are hinged to the inner swing plates, third hydraulic cylinders are arranged on the connection frame, and piston rods of the third hydraulic cylinders are hinged to the inner swing plates.

6. The swinging wing plate structure for providing buoyancy for a ship body according to claim 5, wherein an upper surface of each wing plate is a downwardly curved arc surface, a lower surface of each wing plate is a curved step surface, step drops are connected by an arc surface, and each wing plate is an arc plate with a section of a pressing down structure.

7. The swinging wing plate structure for providing buoyancy for a ship body according to claim 5, wherein free ends of the wing plates are provided with vertical plates, lower surfaces of the wing plates are provided with ribs, and the ribs are arranged parallel to the vertical plates.

8. A ship body, provided with a swinging wing plate structure for providing buoyancy for the ship body.

9. The ship body according to claim 8, comprising a ship main body, wherein the ship main body is provided with vertical structures on two sides and inclined plates in front and rear, two ends of the vertical structures on the two sides extend out of the inclined plates in the front and rear of the ship main body, lower ends of the vertical structures extend out of a bottom of the ship main body, accommodating grooves are provided on the two sides of the ship main body, and wing plate structures are arranged in the accommodating grooves.
